(19) United States
(12) Patent Application Publication
(10) Pub. No.: US 2019/0136746 A1
(43) Pub. Date: May 9, 2019

(54) METHODS FOR CONTROLLING TURBOCHARGER COMPRESSOR AIR COOLING SYSTEMS

(71) Applicant: GM GLOBAL TECHNOLOGY OPERATIONS LLC, Detroit, MI (US)

(72) Inventors: Mark R. Claywell, Birmingham, MI (US); Maqsood Rizwan Ali Khan, Rochester Hills, MI (US)

(21) Appl. No.: 15/804,202

(22) Filed: Nov. 6, 2017

(51) Int. Cl. F02B 29/04

(52) U.S. Cl. CPC F02B 29/0493; F02B 37/00; F02B 29/0443; F02B 29/0462

(57) ABSTRACT

Provided are methods controlling systems including a turbocharger configured to compress air for an engine, a cooler configured to receive turbocharged compressed air, a radiator, a coolant circuit for circulating coolant between the cooler and the radiator and including a bypass to manipulate coolant flow through the cooler. The methods include closing the bypass when engine speed and/or load exceeds a threshold, and otherwise one or more of reducing coolant flow through the cooler when the coolant temperature entering the cooler is higher than the compressed air temperature entering the cooler, manipulating coolant flow through the cooler based on the temperature of the compressed air received by the engine, and reducing coolant flow through the cooler when the temperature of the coolant entering the radiator is less than a temperature of the ambient air. Reducing coolant flow through the cooler reduces the coolant pressure drop within the coolant circuit.

### BACKGROUND

During a combustion cycle of an internal combustion engine (ICE), air/fuel mixtures are provided to cylinders of the ICE. The air/fuel mixtures are compressed and/or ignited and combusted to provide output torque. Many diesel and gasoline ICEs employ a supercharging device, such as an exhaust gas turbine driven turbocharger, to compress the airflow before it enters the intake manifold of the engine in order to increase power and efficiency. Specifically, a turbocharger utilizes exhaust gas to power a turbine which in turn drives a compressor. The compressor delivers higher density air, relative to what is achievable with ambient atmospheric pressure, to the cylinders of the ICE. The additional mass of oxygen-containing air that is forced into the ICE improves the engine's volumetric efficiency, allowing it to burn more fuel in a given cycle, and thereby produce more power. Air communicated from the turbocharger increases in heat during compression, and is often cooled prior to its introduction to one or more cylinders of the ICE.

### SUMMARY

Methods for controlling a turbocharger compressor air cooling systems are provided. The systems includes a turbocharger, having a compressor configured to compress and a cooler configured to receive compressed air from the compressor, a radiator, a coolant circuit configured to circulate coolant between the cooler and the radiator such that the coolant can thermally interact with the compressed air in the cooler and ambient air in the radiator, wherein the coolant circuit comprises a bypass including a bypass inlet in fluid communication with a portion of the cooling circuit between a coolant outlet of the radiator and a coolant inlet of the cooler and a bypass outlet in fluid communication with a portion of the cooling circuit between a coolant outlet of the cooler and a coolant inlet of the radiator, wherein the flow rate of coolant through the cooler can be manipulated by opening and/or closing the bypass, and an internal combustion engine (ICE) configured to receive compressed air from the cooler. The methods can include reducing coolant flow through the cooler by opening the bypass when the temperature of the coolant entering the cooler is higher than the temperature of the compressed air entering the cooler. The method can include at least partially isolating the cooler from the coolant circuit by opening the bypass when the temperature of the coolant entering the cooler is higher than the temperature of the compressed air entering the cooler minus a buffer value. The buffer value can be a fixed value. The buffer value can increase when one or more of ICE load and ICE speed decrease. The buffer value can decrease when one or more of ICE load and ICE speed increase. The bypass inlet can be disposed closer to the coolant inlet of the cooler than the coolant outlet of the radiator. The flow rate of coolant through the cooler can be reduced by opening the bypass which reduces the pressure drop of the coolant within the coolant circuit.

Methods for controlling a turbocharger compressor air cooling systems are provided. The systems can include a turbocharger including a compressor configured to compress air, a cooler configured to receive compressed air from the compressor, a radiator, a coolant circuit configured to circulate coolant between the cooler and the radiator such that the coolant can thermally interact with the compressed air in the cooler and ambient air in the radiator, wherein the coolant circuit comprises a bypass including a bypass inlet in fluid communication with a portion of the cooling circuit between a coolant outlet of the radiator and a coolant inlet of the cooler and a bypass outlet in fluid communication with a portion of the cooling circuit between a coolant outlet of the cooler and a coolant inlet of the radiator, wherein the flow rate of coolant through the cooler can be manipulated by opening and/or closing the bypass, and an internal combustion engine (ICE) configured to receive compressed air from the cooler. The methods can include manipulating the flow rate of coolant through the cooler by opening or closing the bypass based on the temperature of the compressed air received by the ICE. The flow rate of coolant through the cooler can be manipulated by reducing the flow rate of coolant through the cooler when the temperature of compressed air received by the ICE falls below a minimum air temperature threshold. The flow rate of coolant through the cooler can be manipulated by increasing the flow rate of coolant through the cooler when the temperature of compressed air received by the ICE exceeds a maximum air temperature threshold. The flow rate of coolant through the cooler can be manipulated to achieve a desired temperature of compressed air received by the ICE, and the desired temperature can be determined based on one or more of ICE load and ICE speed. The bypass can be valve-controlled. The bypass inlet can be disposed closer to the coolant inlet of the cooler than the coolant outlet of the radiator. The flow rate of coolant through the cooler can be reduced by opening the bypass, which reduces the pressure drop of the coolant within the coolant circuit.

Methods for controlling a turbocharger compressor air cooling systems are provided. The systems can include a turbocharger including a compressor configured to compress air, a cooler configured to receive compressed air from the compressor, a radiator, a coolant circuit configured to circulate coolant between the cooler and the radiator such that the coolant can thermally interact with the compressed air in the cooler and ambient air in the radiator, wherein the coolant circuit comprises a bypass including a bypass inlet in fluid communication with a portion of the cooling circuit between a coolant outlet of the radiator and a coolant inlet of the cooler and a bypass outlet in fluid communication with a portion of the cooling circuit between a coolant outlet of the cooler and a coolant inlet of the radiator, wherein the flow rate of coolant through the cooler can be manipulated by opening and/or closing the bypass, and an internal combustion engine (ICE) configured to receive compressed air from the cooler. The methods can include operating in closed-loop control by substantially closing the bypass when the ICE speed exceeds an ICE speed threshold and/or when the ICE torque exceeds an ICE torque threshold, and if the ICE speed is below the speed threshold and the ICE torque is below the torque threshold, operating in open-loop control by one or more of reducing coolant flow through the cooler by opening the bypass when the temperature of the coolant entering the cooler is higher than the temperature of the compressed air entering the cooler, manipulating the flow rate of coolant through the cooler by opening or closing the bypass based on the temperature of the compressed air received by the ICE, and reducing coolant flow through the cooler by opening the bypass when the temperature of the coolant entering the radiator is less than a temperature of the ambient air. Reducing the flow rate of coolant through the cooler by opening the bypass can reduce the pressure drop of the coolant within the coolant circuit. The bypass inlet can be disposed closer to the coolant inlet of the cooler than the coolant outlet of the radiator. The flow rate of coolant through the cooler can be manipulated to achieve a desired temperature of compressed air received by the ICE, and the desired temperature can be determined based on one or more of ICE load and ICE speed. The ICE speed threshold can be one or more of an ICE speed or a rate of change of the ICE speed, and/or the ICE torque threshold can be one or more of an ICE torque or a rate of change of the ICE torque. Coolant flow through the cooler can be reduced by opening the bypass when the temperature of the coolant entering the cooler is higher than the temperature of the compressed air entering the cooler minus a buffer value. The buffer value can vary inversely to changes in one or more of ICE load and ICE speed increase.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 is a schematic diagram of an internal combustion engine system, according to one or more embodiments.

FIG. 2 is a block diagram of a method for a turbocharger compressor air cooling system, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are internal combustion engine (ICE) systems, particularly turbocharged and/or supercharged ICE systems, incorporating coolers configured to cool compressed air prior to communication of the same to an ICE. The systems and methods herein utilize coolant bypass loops to effect efficient and dynamic control of coolers such that ICE performance and overall system efficiency is enhanced.

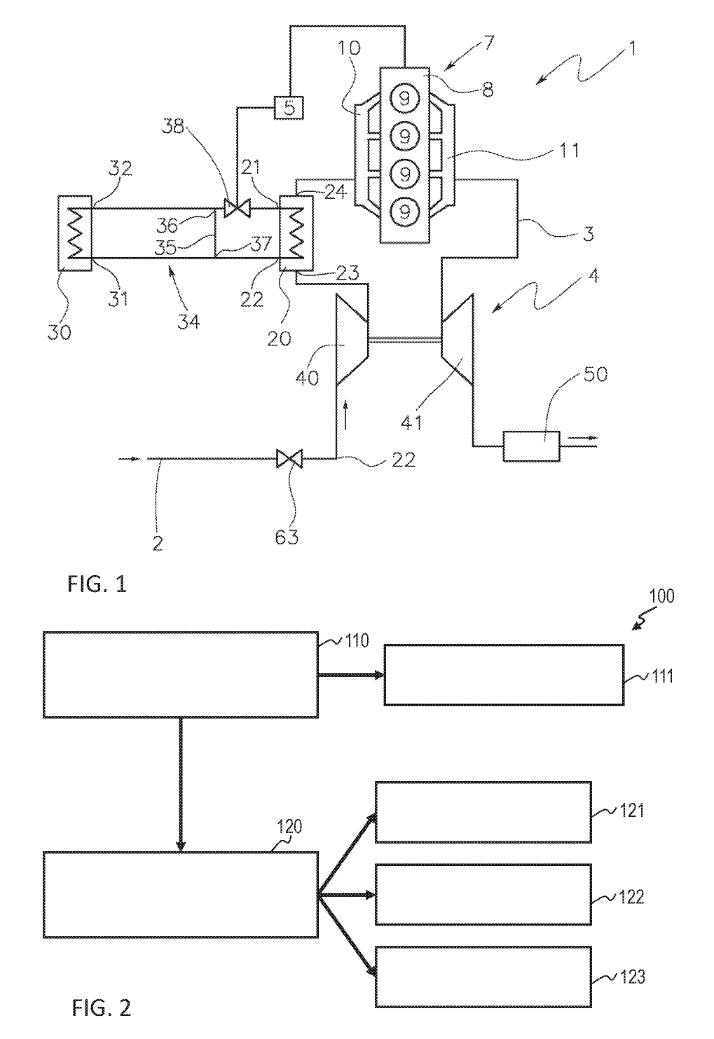

FIG. 1 illustrates a schematic view of a turbocharged internal combustion engine (ICE) system 1. System 1 comprises an ICE 7 having an intake manifold 10 and an exhaust manifold 11, an air intake line 2 for conveying fresh air from the ambient in the intake manifold 10, an exhaust line 3 for conveying the exhaust gas from the exhaust manifold 11 to the ambient, and a turbocharger 4 which comprises a compressor 40 located in the intake line 2 for compressing the air stream flowing therein, and a turbine 41, located in the exhaust line 3 for driving said compressor 40, for example via a common shaft. System 1 can further comprise an electronic control module (ECM) 5 configured to accomplish control within system 1 in accordance with control methods and strategies described herein. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality. For example, ECM 5 can be operatively connected to various components of ICE 7, various temperature sensors (not shown), and one or more valves, among other components.

ICE 7 can be of a spark ignition or a compression ignition design. ICE 7 generally includes an engine block 8 which defines a plurality of cylinders 9. ICE 7 is illustrated as an inline four cylinder arrangement for simplicity. However, it is understood that the present teachings apply to any number of piston-cylinder arrangements and a variety of reciprocating engine configurations including, but not limited to, V-engines, inline engines, and horizontally opposed engines, as well as both overhead cam and cam-in-block configurations. In some specific embodiments, ICE 7 can comprise an inline three or six cylinder engine. In other specific embodiments, ICE 7 can comprise V-6, V-8, V-10, and V-12 configuration engines, among others. Each of the cylinders 9 can include a piston (not shown) configured to reciprocate therein, wherein a cylinder and its respective piston can define a combustion chamber into which fuel and air are injected. Fuel combustion within a cylinder reciprocates the associated piston, and a crankshaft (not shown) converts the reciprocating motion of the pistons to rotational motion. The crankshaft can communicate tractive torque to the drivetrain of a vehicle, for example. Each of the cylinders receives air via intake manifold 10. Cylinders may also receive exhaust gas via low pressure and/or high pressure exhaust gas recirculation systems (not shown). Exhaust gas expelled from the cylinders after combustion can be directed via exhaust line 3 to one or more exhaust gas treatment devices 50.

The turbocharged Diesel engine system further comprises a cooler 20 located in the intake line 2 downstream the compressor 40 of turbocharger 4, for cooling the air stream before it reaches the intake manifold 10. Cooler 20 utilizes a coolant circuit 34 to extract heat from compressed in the cooler 20 via coolant, and release heat from the coolant to the ambient via a radiator 30. Coolant enters the cooler 20 at a cooler inlet 21 and exits the cooler 20 at cooler outlet 22. Similarly, coolant enters the radiator 30 at a radiator inlet 31 and exits the radiator 30 at a radiator outlet 32. Cooler 20 is generally configured to facilitate heat exchange between compressed air and coolant from coolant circuit 34. Cooler 20 can, in some embodiments, additionally receive and cool exhaust gas, such as exhaust gas recirculated by a high pressure and/or low pressure exhaust gas recirculation systems (not shown). Radiator 30 can be a low temperature radiator (LTR). The temperatures of the coolant at cooler inlet 21, cooler outlet 22, radiator inlet 31, and radiator outlet 32 can be denoted T_{CCI}, T_{CCO}, T_{CRI}, and T_{CRO}, respectively. Compressed air enters the cooler 20 at air inlet 23 and exits the cooler 20 at air exit 24. The temperatures of the compressed air at air inlet 23 and air exit 24 can be denoted T_{ACI}, and T_{ACO}, respectively. The temperature of ambient air can be denoted T_{AMB}.

Compressed air communicated from compressor 40 increases in temperature during compression, which decreases the oxygen density of the air by volume. Cooler 20 cools the compressed air to increase oxygen density and consequently the volumetric efficiency of ICE 7. The desired temperature of the compressed air communicated to ICE 7 can be determined based on many factors such as ICE 7 load, ICE 7 speed, vehicle speed, ambient temperature, and ICE 7 calibration (e.g., desired fuel:air ratio), among others. ICE 7 load can refer to the torque generated by ICE 7, or a torque command, such as determined by a vehicle accelerator pedal, and/or ECM 5. ICE 7 load can be directly measured or modelled, for example. ICE 7 speed can refer to the rotations per minute (rpm) of the crankshaft. ICE 7 speed can be directly measured or modelled, for example. In some scenarios, such as high ICE 7 torque and/or high ICE 7 speed, maximum cooling of compressed air is required. In other scenarios, compressed air must only be cooled above a desired threshold. In some scenarios, when T_{CCI}>T_{ACI} or when T_{AMB}>T_{CRI}, it is not possible to cool the compressed air using cooler 20.

To effect more efficient control of compressed air cooling, coolant circuit 34 further comprises a bypass 35. Bypass 35 can be generally utilized to minimize coolant flow through cooler 20 when cooling compressed air is either not possible, or not necessary or desired. Further, opening or partially opening bypass 35 reduces the pressure drop of circulating coolant, as cooler 20 is typically responsible for a large portion of the coolant pressure drop within coolant circuit 34. Accordingly, coolant circulation power demands can be reduced, and/or the rate of cooling of coolant in radiator 30 can be increased due to the increased rate of coolant circulation therethrough. Bypass 35 comprises a bypass inlet 36 in fluid communication with a portion of the cooling circuit 34 between the radiator outlet 32 and the cooler inlet 21, and a bypass outlet 37 in fluid communication with a portion of the cooling circuit 34 between the cooler outlet 22 and the radiator inlet 31. The flow rate of coolant through the cooler 20 can be manipulated via the bypass. Specifically, increasing coolant flow (i.e., opening) the bypass 35 decreases coolant flow through the cooler 20, and decreasing coolant flow (i.e., closing) the bypass 35 increases coolant flow through the cooler 20. While the bypass 35 is open at least partially open, a first portion of coolant actively circulates between the bypass 35 and radiator 30 and the active coolant may cool within radiator 30 subject to T_{AMB}. A second portion of coolant remains static, or partially static, within cooler 20 and optionally between cooler 20 and bypass 35, and the second portion of coolant can become hotter relative to the first portion of coolant. When bypass 35 is opened and the first, static portion of coolant begins to circulate, the disparate temperatures of the first and second coolant portions can cause an undesired coolant cooling transient. Accordingly, in some embodiments, the bypass inlet 36 is disposed closer to the cooler inlet 21 of cooler 20 than the radiator outlet 32 of the radiator 30 in order to minimize the magnitude of the first, static or partially static coolant portion.

The bypass can be manipulated to and between fully opened and fully closed positions. When the bypass is in a fully closed position, coolant flow through the cooler 20 is maximized. In some embodiments, maximizing coolant flow through the cooler 20 comprises zero coolant flow through the bypass. Similarly, when the bypass is in a fully open position coolant flow through the cooler is minimize. In some embodiments, when the bypass is in a fully open position, there is zero coolant flow through the cooler 20. In other embodiments, when the bypass is in a fully open position, there is some or minimal coolant flow through the cooler 20. In some embodiments, the bypass 35 can be manipulate by a valve, such as valve 38. Valve 38 is shown as a two-way valve disposed between bypass inlet 36 and cooler inlet 21, but other configurations are suitable. For example, valve 38 can be disposed proximate to or integrated with cooler inlet 21, or can be disposed in bypass 35 between bypass inlet 36 and bypass outlet 37. In another example, valve 38 can comprises a three-way valve disposed at bypass inlet 36. In another example, valve 38 can be disposed at or between cooler outlet 22 and bypass outlet 37. In general, valve 38 can be disposed anywhere in a coolant sub-circuit defined by the bypass 35 and the cooler 20. Valve 38 can be controlled by ECM 5, for example.

FIG. 2 illustrates a method 100 for a turbocharger compressor air cooling system. Method 100 will be described in reference to system 1 for the purpose of illustration, but is not intended to be limited thereby. In particular, system 1 describes basic aspect of a traditional ICE system, but method 100 may be suitably applied to electric and hybrid electric vehicle systems, and systems incorporation additional features such as high pressure EGR and/or low pressure EGR components. Method 100 can comprise operating 120 in an open loop mode to control the bypass 35. Open loop mode can comprise one or more of opening 121 the bypass 35 to reduce the flow of coolant through the cooler 20 when T_{CCI}>T_{ACI}, manipulating 122 the bypass 35 based on T_{ACO} (i.e., the temperature of the compressed air received by ICE 7), and opening 123 the bypass 35 to reduce the flow of coolant through the cooler 20 when T_{CRI}>T_{AMB}.

Opening 121 the bypass 35 can comprise at least partially opening the bypass 35, substantially opening the bypass 35, completely opening the bypass 35, or dynamically opening the bypass 35 based on varying T_{CCI} and/or T_{ACI}. When T_{CCI}>T_{ACI}, it is not possible for the coolant to extract heat from the compressed air in cooler 20, and therefore it is desired to reduce or halt coolant flow through cooler 20. In some embodiments, open loop mode can comprises one or more of opening 121 the bypass to reduce the flow of coolant through the cooler 20 when T_{CCI}>(T_{ACI}−Buffer), wherein the buffer is a temperature correction value used to stabilize bypass 35 manipulation, particularly during dynamic ICE 7 operating conditions. The buffer can be a fixed value, or can be dynamically determined. For example, the buffer can be determined via a data map that varies the buffer based on one or more parameters, such as ICE 7 load and/or ICE 7 speed. In one embodiment, the buffer can vary inversely to changes in one or more of ICE 7 load and ICE 7 speed increase. Specifically, in one embodiment, the buffer can increase when one or more of ICE 7 load and ICE 7 speed decrease. In another embodiment, the buffer value can decrease when one or more of ICE 7 load and ICE 7 speed increase. The buffer can be determined based on a data map which determines the buffer as a function of ICE 7 load. The buffer can be determined based on a data map which determines the buffer as a function of ICE 7 speed. The buffer can be determined based on a data map which determines the buffer as a function of ICE 7 load and ICE 7 speed.

Manipulating 122 the bypass 35 based on T_{ACO} can comprise opening or closing the bypass 35 to manipulate the flow rate of coolant through the cooler 20 in order to achieve a desired T_{ACO}. A desired T_{ACO} can be determined based upon desired ICE 7 operating calibrations and/or general efficiency of system 1. In one embodiment, manipulating 122 the flow rate of coolant through the cooler 20 comprises reducing the flow rate of coolant through the cooler 20 by opening the bypass 35 when T_{ACO} falls below a minimum T_{ACO} threshold. The minimum T_{ACO} threshold can be determined in order to prevent excessive cooling of compressed air, and/or ensure a proper temperature of compressed air communicated to ICE 7, for example. In another embodiment, manipulating 122 the flow rate of coolant through the cooler 20 comprises increasing the flow rate of coolant through the cooler 20 by closing the bypass 35 when T_{ACO} exceeds a maximum T_{ACO} threshold. The maximum T_{ACO} threshold can be determined in order to ensure a proper temperature of compressed air communicated to ICE 7, for example. The flow rate of coolant through the cooler 20 can be manipulated to achieve a desired T_{ACO}, wherein the desired T_{ACO} can be determined based on one or more of ICE 7 load and ICE 7 speed. Similarly, the minimum T_{ACO} threshold and the maximum T_{ACO} threshold can be determined based on one or more of ICE 7 load and ICE 7 speed. Each of the desired T_{ACO}, the minimum T_{ACO} threshold, and the maximum T_{ACO} threshold can be determined based on a data map which determines the buffer as a function of ICE 7 load. Each of the desired T_{ACO}, the minimum T_{ACO} threshold, and the maximum T_{ACO} threshold can be determined based on a data map which determines the buffer as a function of ICE 7 speed. Each of the desired T_{ACO}, the minimum T_{ACO} threshold, and the maximum T_{ACO} threshold can be determined based on a data map which determines the buffer as a function of ICE 7 load and ICE 7 speed.

Opening 123 the bypass 35 can comprise at least partially opening the bypass 35, substantially opening the bypass 35, completely opening the bypass 35, or dynamically opening the bypass 35 when T_{CRI}>T_{AMB}. When T_{CRI}>T_{AMB}, it is not possible for the coolant to release heat to the ambient via radiator 30, and therefore it is desired to reduce or halt coolant flow through cooler 20 to prevent heating of compressed air.

Method 100 can optionally include, prior to operating 120 in open-loop control, operating 110 in closed-loop control if one or more of ICE 7 load or ICE 7 speed exceed a threshold. Operating 120 in closed-loop control can comprise closing 111 or substantially closing 111 bypass 35. When ICE 7 operates at high speed and/or load, a need for increased or high delivery of compressed air to ICE 7 can exist. Accordingly, closing 111 or substantially closing 111 bypass 35 provides maximum or near maximum cooling to compressed air via cooler 20. System 1 can subsequently operate 120 in open-loop mode if one or more of ICE 7 load or ICE 7 speed drop below a threshold and operate 120 in open-loop mode. An ICE 7 load threshold and/or an ICE 7 speed threshold can be pre-calibrated, or determined via a data map. The calibration of a load and/or speed threshold can be determined based upon the cooling capacities of the radiator 30 and the cooler 20, the heat generated by ICE 7, and the ideal operating temperatures of ICE 7, for example.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for controlling a turbocharger compressor air cooling system comprising a turbocharger including a compressor configured to compress air, a cooler configured to receive compressed air from the compressor, a radiator, a coolant circuit configured to circulate coolant between the cooler and the radiator such that the coolant can thermally interact with the compressed air in the cooler and ambient air in the radiator, wherein the coolant circuit comprises a bypass including a bypass inlet in fluid communication with a portion of the cooling circuit between a coolant outlet of the radiator and a coolant inlet of the cooler and a bypass outlet in fluid communication with a portion of the cooling circuit between a coolant outlet of the cooler and a coolant inlet of the radiator, wherein a flow rate of coolant through the cooler can be manipulated by opening and/or closing the bypass, and an internal combustion engine (ICE) configured to receive compressed air from the cooler the method comprising:
reducing coolant flow through the cooler by opening the bypass when a temperature of the coolant entering the cooler is higher than a temperature of the compressed air entering the cooler.

2. The method of claim 1, wherein the method comprises at least partially isolating the cooler from the coolant circuit by opening the bypass when the temperature of the coolant entering the cooler is higher than the temperature of the compressed air entering the cooler minus a buffer value.

3. The method of claim 2, wherein the buffer value is a fixed value.

4. The method of claim 2, wherein the buffer value increases when one or more of ICE load and ICE speed decrease.

5. The method of claim 2, wherein the buffer value decreases when one or more of ICE load and ICE speed increase.

6. The method of claim 1, wherein the bypass inlet is disposed closer to the coolant inlet of the cooler than the coolant outlet of the radiator.

7. The method of claim 1, wherein reducing the flow rate of coolant through the cooler by opening the bypass reduces a pressure drop of the coolant within the coolant circuit.

8. A method for controlling a turbocharger compressor air cooling system comprising a turbocharger including a compressor configured to compress air, a cooler configured to receive compressed air from the compressor, a radiator, a coolant circuit configured to circulate coolant between the cooler and the radiator such that the coolant can thermally interact with the compressed air in the cooler and ambient air in the radiator, wherein the coolant circuit comprises a bypass including a bypass inlet in fluid communication with a portion of the cooling circuit between a coolant outlet of the radiator and a coolant inlet of the cooler and a bypass outlet in fluid communication with a portion of the cooling circuit between a coolant outlet of the cooler and a coolant inlet of the radiator, wherein a flow rate of coolant through the cooler can be manipulated by opening and/or closing the bypass, and an internal combustion engine (ICE) configured to receive compressed air from the cooler, the method comprising:
manipulating the flow rate of coolant through the cooler by opening or closing the bypass based on a temperature of the compressed air received by the ICE.

9. The method of claim 8, wherein manipulating the flow rate of coolant through the cooler comprises reducing the flow rate of coolant through the cooler when the temperature of compressed air received by the ICE falls below a minimum air temperature threshold.

10. The method of claim 8, wherein manipulating the flow rate of coolant through the cooler comprises increasing the flow rate of coolant through the cooler when the temperature of compressed air received by the ICE exceeds a maximum air temperature threshold.

11. The method of claim 8, wherein the flow rate of coolant through the cooler is manipulated to achieve a desired temperature of compressed air received by the ICE, and the desired temperature is determined based on one or more of ICE load and ICE speed.

12. The method of claim 8, wherein the bypass is valve-controlled.

13. The method of claim 8, wherein the bypass inlet is disposed closer to the coolant inlet of the cooler than the coolant outlet of the radiator.

14. The method of claim 8, wherein reducing the flow rate of coolant through the cooler by opening the bypass reduces a pressure drop of the coolant within the coolant circuit.

15. A method for controlling a turbocharger compressor air cooling system comprising a turbocharger including a compressor configured to compress air, a cooler configured to receive compressed air from the compressor, a radiator, a coolant circuit configured to circulate coolant between the cooler and the radiator such that the coolant can thermally interact with the compressed air in the cooler and ambient air in the radiator, wherein the coolant circuit comprises a bypass including a bypass inlet in fluid communication with a portion of the cooling circuit between a coolant outlet of the radiator and a coolant inlet of the cooler and a bypass outlet in fluid communication with a portion of the cooling circuit between a coolant outlet of the cooler and a coolant inlet of the radiator, wherein a flow rate of coolant through the cooler can be manipulated by opening and/or closing the bypass, and an internal combustion engine (ICE) configured to receive compressed air from the cooler, the method comprising:
operating in closed-loop control by substantially closing the bypass when the ICE speed exceeds an ICE speed threshold and/or when the ICE torque exceeds an ICE torque threshold; and
if the ICE speed is below the speed threshold and the ICE torque is below the torque threshold, operating in open-loop control by one or more of:
reducing coolant flow through the cooler by opening the bypass when a temperature of the coolant entering the cooler is higher than a temperature of the compressed air entering the cooler, manipulating the flow rate of coolant through the cooler by opening or closing the bypass based on a temperature of the compressed air received by the ICE, and
reducing coolant flow through the cooler by opening the bypass when a temperature of the coolant entering the radiator is less than a temperature of the ambient air,
wherein reducing the flow rate of coolant through the cooler by opening the bypass reduces a pressure drop of the coolant within the coolant circuit.

16. The method of claim 15, wherein the bypass inlet is disposed closer to the coolant inlet of the cooler than the coolant outlet of the radiator.

17. The method of claim 15, wherein the flow rate of coolant through the cooler is manipulated to achieve a desired temperature of compressed air received by the ICE, and the desired temperature is determined based on one or more of ICE load and ICE speed.

18. The method of claim 15, wherein the ICE speed threshold comprises one or more of an ICE speed or a rate of change of the ICE speed, and/or the ICE torque threshold comprises one or more of an ICE torque or a rate of change of the ICE torque.

19. The method of claim 15, wherein coolant flow through the cooler is reduced by opening the bypass when the temperature of the coolant entering the cooler is higher than the temperature of the compressed air entering the cooler minus a buffer value.

20. The method of claim 19, wherein the buffer value varies inversely to changes in one or more of ICE load and ICE speed increase.
